(19) United States
(12) Patent Application Publication
(10) Pub. No.: US 2012/0024413 A1
(43) Pub. Date: Feb. 2, 2012

(54) THREE-WAY STRUCTURE

(75) Inventors: Shengmei YANG, Wuxi (CN); Baojun CHANG, Wuxi (CN)

(73) Assignees: JOHNSON CONTROLS BUILDING EFFICIENCY TECHNOLOGY (WUXI) COMPANY, LTD., Wuxi (CN); JOHNSON CONTROLS TECHNOLOGY COMPANY, Holland, MI (US)

(21) Appl. No.: 13/111,294

(22) Filed: May 19, 2011

(30) Foreign Application Priority Data
Jul. 27, 2010 (CN) 201020274843.8

(51) Int. Cl. F16L 9/22

(52) U.S. Cl. 138/155

(57) ABSTRACT

The disclosure provides a three-way structure, including a straight tube and a branch tube perpendicular to and connected with the straight tube, is characterized in that the inner surface of the straight tube is provided with a hollow structure surrounding the straight tube. The three-way structure of the disclosure can both attenuate the noise and simplify the pipeline arrangement of the unit.

### CROSS REFERENCES TO RELATED APPLICATIONS

This application is a continuation in part of and claims priority from and benefit of China Application No. 201020274843.8, entitled “A THREE-WAY STRUCTURE,” filed on Jul. 27, 2010, which application is hereby incorporated by reference in its entirety.

### TECHNICAL FIELD

The disclosure relates to a three-way structure for a variable frequency screw unit, particularly to a three-way structure that can effectively attenuate the exhaust noise of the variable frequency screw unit.

### BACKGROUND

A three-way valve is generally used for conveying the flow of fluid, gas or other flowable substance, or for distributing single path flowable substance into multiple paths. For example, the refrigerant is distributed into two paths by a three-way valve in the chilling system of a variable frequency screw unit.

FIG. 1 illustrates the operating principle of a chilling system in a variable frequency screw unit. As shown in FIG. 1, the chilling system mainly includes a compressor 101, a tee connection 102, muffler 103A and 103B, oil separators 104A and 104B, a condenser 105, a throttle valve 106 and an evaporator 107.

In the variable frequency screw unit, the refrigerant gas with low temperature and low pressure is compressed into the gas with high temperature and high pressure by the compressor 101, then distributed into two paths by means of the tee connection 102, and subsequently transmitted to the oil separators 104A and 104B provided in the downstream via the muffler 103A and 103B which are used for reducing the pressure pulsation of the refrigerant and noise in the tubes respectively. The refrigerant with high temperature and high pressure is delivered to the condenser 105 via the oil separators 104A and 104B, so as to be condensed into liquid with high temperature and high pressure, and then throttled into liquid and vapor with low temperature and low pressure via the throttle valve 106. The liquid with low temperature, low pressure is evaporated into gas with low temperature and low pressure by means of the evaporator 107, and then delivered to the compressor 101, so that a refrigeration cycle is completed in the entire chilling system.

The exhaust pipeline and the oil separators are the main downstream devices of the screw unit that radiate exhaust noise. The larger their diameters are, the lower rigidity their wall structure has, and thus the stronger the structural mode of vibration and noise generation becomes. The larger their diameters, the higher the noise radiation for the same excitation source. Furthermore, it will be more difficult to design an exhaust muffler located outside the compressor if the diameter of the exhaust pipeline becomes larger, particularly to design a muffler suitable for a variable frequency screw unit. Therefore, in order to avoid increasing the diameters of the exhaust pipeline and the oil separators, the exhaust fluid of the compressor is distributed by means of tee connection 102 to enable the exhaust pipeline and the oil separators to be configured with small diameters. Hence, a tee connection 102 is needed. FIG. 2 is a section view of a tee connection in the prior art, wherein the port 201 is an inlet of the tee connection connected to the exhaust port of the compressor upstream, and the ports 202 and 203 are outlets of the tee connection connected to inlets of the mufflers downstream.

However, the design of the prior art structure makes the pipeline arrangement of the screw unit more difficult and additional pipeline connections need to be added between the tee connection and the mufflers, thereby increasing the noise radiation area and decreasing the efficiency of the muffler.

In view of this, it is necessary to solve the above problems and provide a structure that can both effectively utilize the exhaust muffler and simplify the pipeline arrangement of the unit.

### SUMMARY

A series of simple descriptions are introduced in this section and will be further illustrated in detail in the mode of carrying out the intent of the disclosure. The contents of the disclosure are not intended to limit the critical features and the necessary technical features of the claimed technical solution, and are also not intended to restrict the protection scope of the claimed technical solution.

To solve the above technical problems, the disclosure discloses a three-way structure, including a straight tube (401) and a branch tube (402) perpendicular to and connected with the straight tube (401), characterized in that the inner surface of the straight tube (401) is provided with a hollow structure surrounding the straight tube.

In one embodiment, the diameters of ports (404, 405) of the straight tube (401) are smaller than that of the main body of the straight tube (401).

In a further embodiment, the hollow structure is provided symmetrically with respect to the branch tube (402).

In another embodiment, the hollow structure includes chambers (501, 502) mounted on both sides of the branch tube and are not connected with each other.

In one embodiment, the hollow structure includes chambers (601, 602, 603), which are not connected at the sides near the port of the branch tube, and are connected at the sides far from the port of the branch tube.

In a further embodiment, the chambers (501, 502; 601, 602, 603) are filled with sound absorption material.

In another embodiment, the sound absorption material is glass fiber.

In one embodiment, the hollow structure is a flow channel (701) vertically below the branch tube, and the flow channel (701) is provided with an opening (702) near the port of the branch tube, and the flow channel (701) is connected with the interior of the three-way structure through the opening (702).

In a further embodiment, the flow channel (701) has an annular structure.

In another embodiment, the interior of the straight tube includes first components (803A, 803B; 904A, 904B; 1003A, 1003B; 1204) hermetically connected to the inner wall of the straight tube by connecting pieces (804A, 804B; 905A, 905B; 1004A, 1004B; 1205); and the cross sectional area of the first components (803A, 803B; 904A, 904B; 1003A, 1003B; 1204) is smaller than that of the straight tube.

In one embodiment, the first components (803A, 803B; 904A, 904B; 1003A, 1003B) have frame structures.

In a further embodiment, the first components (803A, 803B; 904A, 904B; 1003A, 1003B) have annular frame structures.

In another embodiment, the three-way structure further includes a second component (1104) formed of sound absorptive material, the second component (1104) having an outer contour corresponding to the inner wall of the straight tube and a facing plate (1105) with porous structure, wherein through holes along the axial direction of the straight tube are disposed in the interior of the second component (1104), and the facing plate (1104) is in contact with the through holes.

In one embodiment, the sound absorptive material is melamine foam or sound absorption material coated with mylar and fibrous protecting layer.

In a further embodiment, the facing plate (1104) has a bottomless cylinder shape.

In another embodiment, the percentage of opening area of the facing plate (1104) is no less than 30%.

In one embodiment, the three-way structure further includes a first component (1204) and a connecting piece (1205) connecting the first component (1204) with the inner wall of the straight tube.

The three-way structure of the disclosure can both attenuate the noise and simplify the pipeline arrangement of the unit.

### DESCRIPTION OF THE DRAWINGS

The following Figures of the disclosure are part of content of the disclosure and used for understanding the disclosure. The examples of the disclosure are shown in the Figures for illustrating the principle of the disclosure, in which:

FIG. 1 illustrates the operation principle of a chilling system in a variable frequency screw unit;

FIG. 2 is a section view of a tee connection in the prior art;

FIG. 3 is a schematic view of a chilling system having a three-way structure of noise attenuation according to the disclosure;

FIG. 4 is a perspective view of the three-way structure of noise attenuation according to the disclosure;

FIG. 5 is a section view of a first embodiment of a three-way structure of reactive noise attenuation according to the disclosure;

FIG. 6 is a section view of a second embodiment of the three-way structure of reactive noise attenuation according to the disclosure;

FIGS. 7A and 7B are section views of a third embodiment of the three-way structure of reactive noise attenuation according to the disclosure;

FIG. 8 is a section view of a fourth embodiment of the three-way structure of reactive noise attenuation according to the disclosure;

FIG. 9 is a section view of a fifth embodiment of the three-way structure of reactive noise attenuation according to the disclosure;

FIG. 10 is a section view of a sixth embodiment of the three-way structure of reactive noise attenuation according to the disclosure;

FIG. 11A is a section view of a first embodiment of a three-way structure of resistance noise attenuation according to the disclosure;

FIG. 11B is an exploded schematic view of the three-way structure of absorptive noise attenuation shown in FIG. 11A;

FIG. 12 is a schematic view of a three-way structure of reactive & absorptive noise attenuation according to the disclosure.

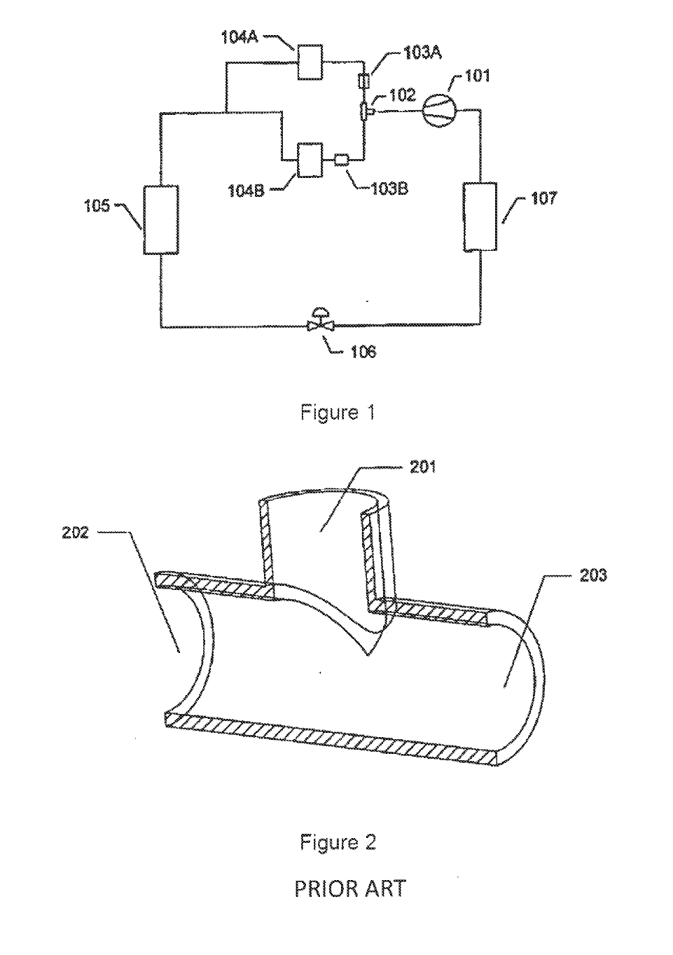

### DETAILED DESCRIPTION

In the following description, details are provided for better understanding the disclosure. However, it is apparent for those skilled in the art that the disclosure can be implemented without one or more of the details. In other embodiments, some technical features well known in the art are not described to avoid being confused with the disclosure.

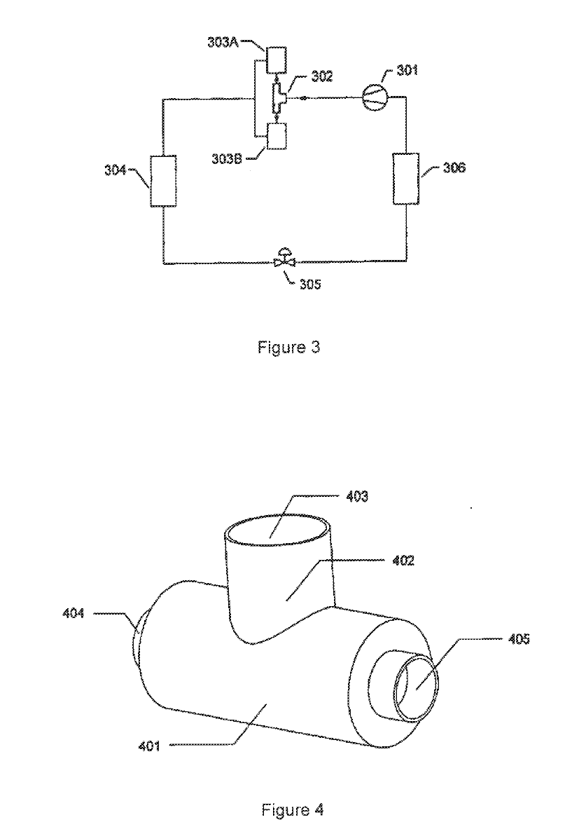

In order to effectively utilize the exhaust muffler, maximize the attenuation of the exhaust noise and simplify the pipeline arrangement of the unit, the disclosure provides a tee connection with noise attenuation function (called a three-way structure of noise attenuation hereinbelow). FIG. 3 is a schematic view of a system having a three-way structure of noise attenuation according to the disclosure. As shown in FIG. 3, the system mainly includes a compressor 301, a three-way structure of noise elimination 302, oil separators 303A, and 303B, a condenser 304, a throttle valve 305 and an evaporator 306. A muffler and a tee connection are integrated together by means of the three-way structure of noise attenuation according to the disclosure, so as to simplify the pipeline arrangement of the unit.

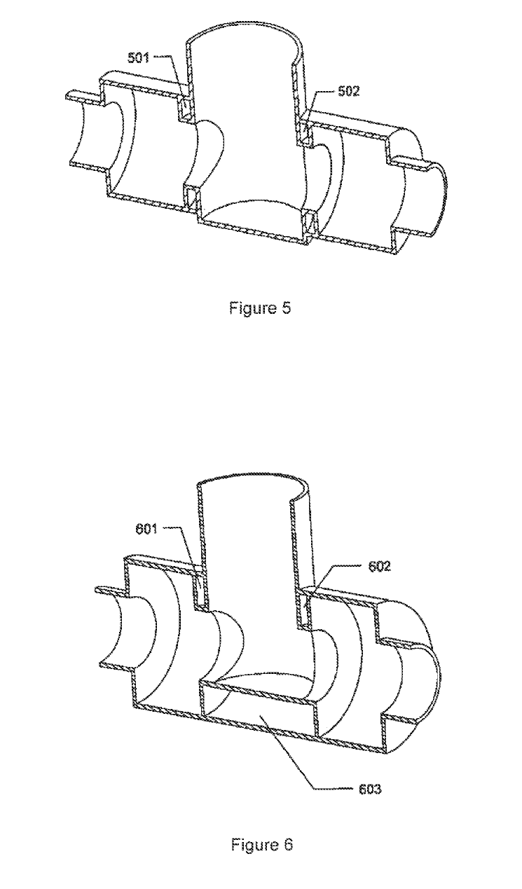

FIG. 4 is a perspective view of a three-way structure of noise attenuation according to the disclosure. As shown in FIG. 4, the three-way structure of noise attenuation includes a straight tube 401 and a branch tube 402 perpendicular to and connected with the straight tube 401. When the three-way structure is applied to the system shown in FIG. 3, port 403 of the branch tube 402 is an inlet of the three-way structure of noise attenuation; ports 404 and 405 of the straight tube 401 are outlets of the three-way structure of noise attenuation. Preferably, the diameter of the port of the straight tube is smaller that of the main body of the straight tube 401. In this way, an exhaust pipeline and oil separator with smaller diameter can be connected at the outlets, so that their wall structure has better rigidity, which can effectively attenuate the noise radiation.

Sound energy radiated by the muffler can be attenuated by means of alteration that change the impedance during transmission of the sound, such as altering the section of the tube or bypassing a resonator, so as to produce the reflecting and interaction of the sound energy, so that the noise is attenuated. Therefore, the three-way structure applying the above noise attenuation principle to achieve the noise attenuation function is called a three-way structure of reactive noise attenuation. In order to attenuate the noise radiation of the three-way structure itself, the inner surface of the straight tube is provided with a hollow structure surrounding the straight tube. In one embodiment, the hollow structure is provided symmetrically with respect to the branch tube, so as to interchangeably use two ports of the straight tube during the mounting of the three-way structure of noise attenuation. Additionally, the symmetrical design is also suitable for industrial manufacture.

The hollow structure can include chambers with a hermetic structure not in contact with the fluid in the three-way structure, and the chambers can be filled with sound absorption material to effectively attenuate the noise radiation. The hollow structure can define a flow channel when it is a structure in communication with the interior of the three-way structure.

The three-way structure of reactive noise attenuation according to the disclosure will be described in detail in conjunction with the following specific examples. FIGS. 5 to 7 show several positions of the hollow structure according to some exemplary embodiments of the disclosure.

### Example 1

As shown in FIG. 5, the inner surface of the straight tube is provided with a hollow structure surrounding the straight tube at both sides of the branch tube, i.e. chambers 501 and 502, which are not in contact with the fluid in the three-way structure. The chambers 501 and 502 are not connected with each other, and are symmetrically disposed at both sides of the branch tube. The chambers 501 and 502 are filled with sound absorption material having good sound absorption characteristic. For example, the sound absorption material is glass fiber.

### Example 2

As shown in FIG. 6, chambers 601 and 602 that are not in contact with the fluid in the three-way structure are not connected at the side near the port of the branch tube, but are connected at the side far from the branch tube via chamber 603. The chambers 601 and 602 are symmetrically provided at both sides of the branch tube, and the chambers 601 and 602 are in communication with chamber 603 respectively. The chambers 601, 602 and 603 are filled with sound absorption material having good sound absorption characteristic. For example, the sound absorption material is glass fiber.

### Example 3

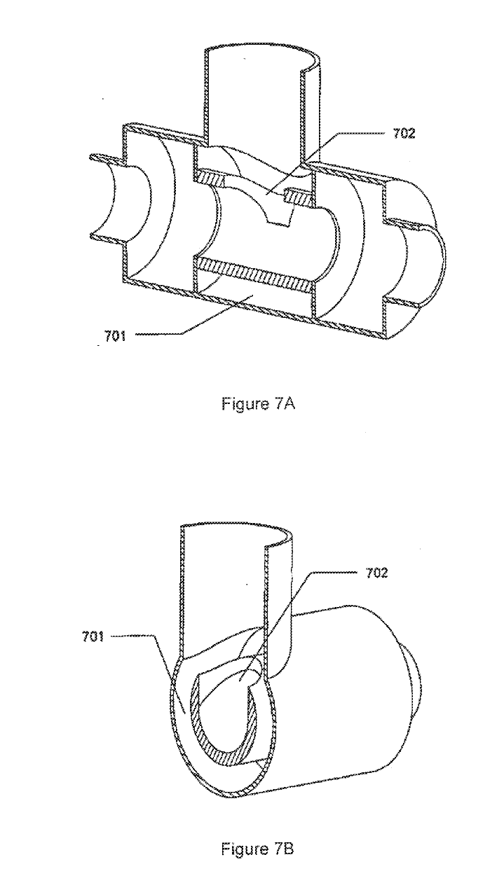

As shown in FIG. 7A, the inner surface of the straight tube is provided with a hollow structure surrounding the straight tube, i.e. a flow channel 701. The flow channel 701 is vertically below the branch tube, and the flow channel 701 is provided with an opening 702 near the port of the branch tube, and the flow channel 701 is in communication with the interior of the entire three-way structure of noise attenuation via the opening 702. As further shown, the flow channel 701 has an annular structure. FIG. 7B is a cross section view of the straight tube in the three-way structure of noise attenuation shown in FIG. 7A. As compared with the embodiments shown in FIGS. 5 and 6, the flow channel 701 is in communication with the interior of the entire three-way structure of noise attenuation, thereby having the function of reducing the noise to some extent.

Furthermore, in order to attenuate the exhaust noise, a first component is provided in the interior of the straight tube, the first component is hermetically connected with the inner wall of the straight tube through connecting pieces, and the cross section area of the first component is smaller than that of the straight tube.

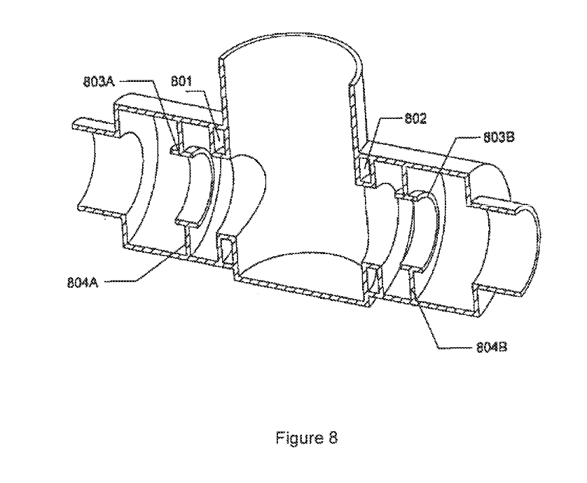

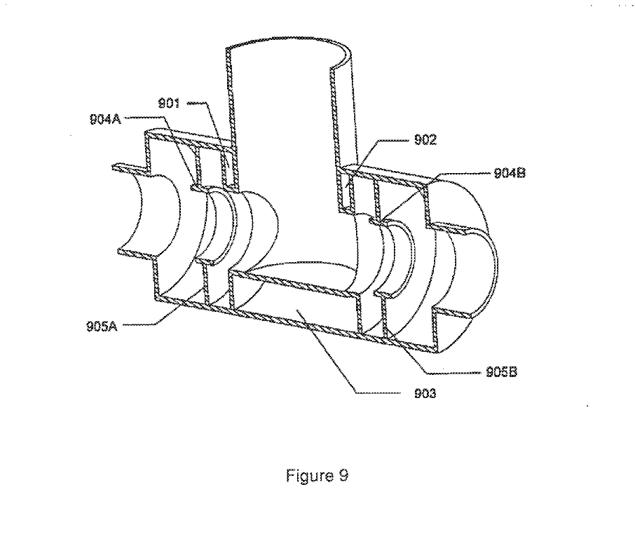

The three-way structure of reactive noise attenuation according to the disclosure will be described in detail in conjunction with the following exemplary embodiments. The three-way structure of reactive noise attenuation shown in FIGS. 8 to 10 is obtained by further adding additional components to the three-way structure of noise attenuation shown in FIGS. 5 to 7.

### Example 4

As shown in FIG. 8, added components 803A and 803B are provided between the ports of the straight tube and the chambers 801, 802 in the interior of the straight tube. The components 803A and 803B are connected with the inner wall of the straight tube through connecting pieces 804A and 804B respectively, so that the fluid flows through the components 803A and 803B, thereby achieving the object of noise attenuation due to the change of the impedance as the fluid flows through the straight tube. As further shown, the components 803A and 803B are symmetrically provided at both sides of the branch tube. The components can be implemented as a frame structure, which can be polygon shape, annular shape and irregular shape etc. In one embodiment, the first components 803A and 803B have a frame structure with an annular shape.

### Example 5

As shown in FIG. 9, added components 904A and 904B are provided between the ports of the straight tube and the chambers 901, 902, 903 in the interior of the straight tube. The components 904A and 904B are connected with the inner wall of the straight tube through connecting pieces 905A and 905B respectively, so that the fluid flows through the first components 904A and 904B, thereby achieving the object of noise attenuation as due to the change of the impedance as the fluid flows through the straight tube. As further shown, the components 904A and 904B are symmetrically provided at both sides of the branch tube. The shape and structure of the components 904A and 904B are similar to those shown in FIG. 8, and hence the details are omitted herein.

### Example 6

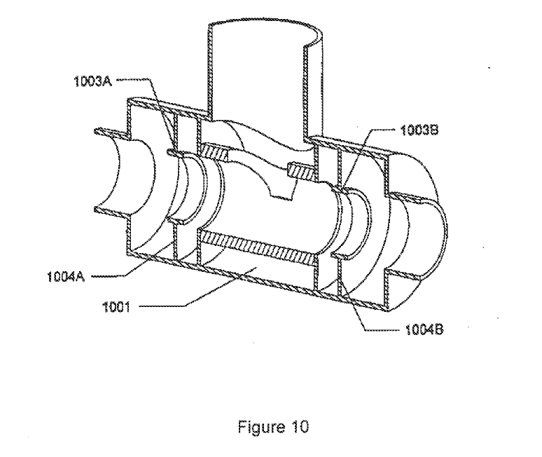

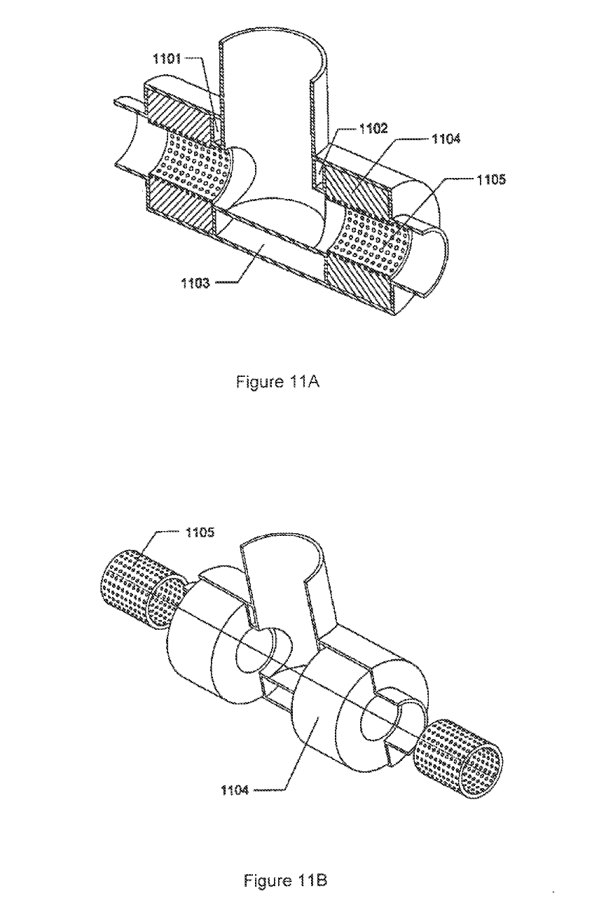

As shown in FIG. 10, added components 1003A and 1003B are provided between the ports of the straight tube and the flow channel 1001 in the interior of the straight tube. The components 1003A and 1003B are connected with the inner wall of the straight tube through connecting pieces 1004A and 1004B respectively, so that the fluid flows through the first components 1003A and 1003B, thereby achieving the object of noise attenuation due to the change of the impedance as the fluid flows through the straight tube. As further shown, the components 1003A and 1003B are symmetrically provided at both sides of the branch tube. The shape and structure of the components 1003A and 1003B are similar to those shown in FIG. 8, and hence the details are omitted herein.

FIGS. 8 to 10 illustrate only three exemplary embodiments, and the three-way structure of noise attenuation according to the disclosure is not limited to the above three examples. The protection scope of the disclosure encompasses the cases where the added component is one or at least two. When there is a plurality of the added components, the added components in the same three-way structure of noise attenuation can be implemented to have different shapes and structures. Additionally, when there is a plurality of the added components, the added components can be disposed at the same side of the branch tube, or at both sides of the branch tube. When a plurality of added components are disposed at both sides of the branch tube, the disclosure encompasses the case where the added components are not symmetrical with respect to the branch tube. The added components can be formed integrally with the connecting pieces.

Optionally, in order to attenuate exhaust noise, a second component and a facing plate are provided in the interior of the straight tube. The second component is formed of sound absorption material and has outer contour corresponding to the inner wall of the straight tube; through holes are disposed along the axial direction of the straight tube in the interior of the second component; the facing plate has a porous structure and is in contact with the through holes. The noise attenuation principle of the above structure is that the sound absorption material absorbs the sound energy and converts it into heat energy or other forms of energy. Therefore, the three-way structure of noise attenuation having the above structure is called the three-way structure of absorptive noise attenuation.

### Example 7

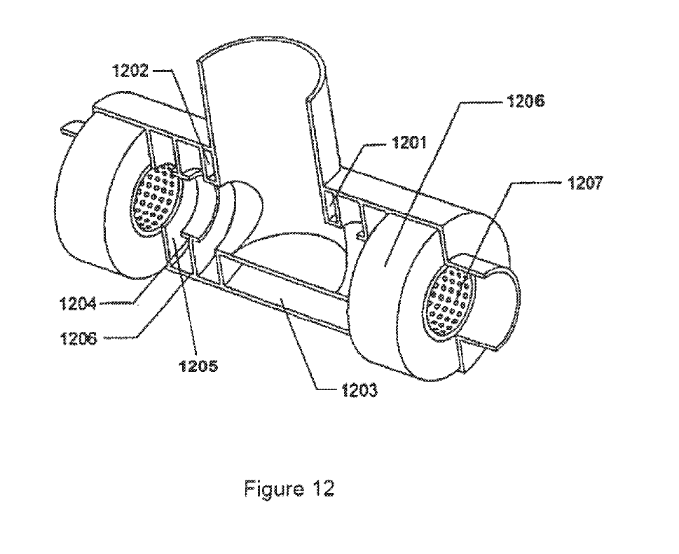

The three-way structure of absorptive noise attenuation according to the disclosure will be described in conjunction with the following exemplary embodiments. The three-way structure of absorptive noise attenuation shown in FIGS. 11A and 11B is obtained by further adding second components into the three-way structure of noise attenuation shown in FIG. 6. FIG. 11A is a section view of a three-way structure of absorptive noise attenuation according to the disclosure; FIG. 11B is an exploded schematic view of the three-way structure of absorptive noise attenuation according to the disclosure.

As shown in FIG. 11A, a second component 1104 is provided between the port of the straight tube and the chambers 1101, 1102, 1103. The second component 1104 is formed of sound absorption material having high chemical stability with respect to the fluid and good sound absorption characteristics, such as melamine foam or sound absorption material coated with mylar and fibrous protecting layer and the like. The second component 1104 has an outer contour corresponding to the inner wall of the straight tube, and through passages are disposed along the axial direction of the straight tube in the interior of the second component, fluid flowing through via the passages. Additionally, in order to protect the second component 1104 from being damaged as a result of the scouring of the high speed fluid, a facing plate 1105 is mounted on the surface of the second component 1104 containing the through passages. The facing plate has a porous structure.

As further shown in FIG. 11A, the through passages provided in the middle of the second component 1104 have a cylinder structure, and the facing plate 1105 has an open cylinder shape. Apertures are disposed throughout the cylinder (as shown in FIG. 11B); the facing plate 1105 is generally formed of steel. The facing plate (1105) has a percentage of opening area of no less than 30%, wherein the percentage of opening area is a ratio of the sum of area of the apertures in the facing plate to the overall area of the facing plate.

The above example only illustrates the three-way structure of noise attenuation obtained for example by further adding a second component to the three-way structure of noise attenuation shown in FIG. 6. The protection scope of the disclosure encompasses all the modifications made to the three-way structure with chambers according to the disclosure.

Additionally, the disclosure provides a three-way structure of compound noise attenuation, which combines the characteristics of the reactive noise attenuation and the absorptive noise attenuation. The three-way structure of compound noise attenuation includes a first component and a second component, wherein the first component is connected with the inner wall of the straight tube through connecting pieces, and the second component has a facing plate. The three-way structure of reactive & absorptive noise attenuation combines the characteristics of the reactive noise attenuation and the absorptive noise attenuation, including both the first component and the second component, so that the three-way structure can be used for an extended frequency range of the noise to be attenuated.

### Example 8

FIG. 12 is a schematic view of a three-way structure of reactive & absorptive noise attenuation according to the disclosure. As shown in FIG. 12, a first component 1204 and a second component 1205, such as a connecting piece, are provided in the area on each side of the chambers 1201, 1202, 1203 and the port of the straight tube. The first component 1204 is connected to the inner wall of the straight tube through the connecting piece 1205, with an outer surface of a second component 1206 positioned adjacent to the inner surface of the straight tube, the second component having a facing plate 1207 that can be configured to be supported by the first component 1204 or second component 1104 (FIG. 11A). As further shown in FIG. 12, the first component 1204 and the second component 1206 are symmetrically disposed at both sides of the branch tube, so that the same efficiency of noise attenuation is obtained in various directions, and the three-way structure of noise attenuation has no directivity.

The above preferable embodiments are only illustrative, and the disclosure also encompasses the case where at least one first component and at least one second component are not symmetrically disposed at both sides of the branch tube. The asymmetry includes that at least one first component and at least one second component are disposed at both sides of the branch tube with asymmetrical positions and asymmetrical numbers.

Comparison of the sound transmission loss between the three-way structure of reactive, absorptive and reactive & absorptive noise attenuation, and comparison of the sound transmission loss between the above preferable three-way structure of reactive noise attenuation with three different inner configurations is also made. For example, if the inlet and outlet of the three-way structure of noise attenuation are 5 inch (127 mm) and 3 inch (76.2 mm) diameter respectively, the noise attenuation characteristic of the three-way structure of reactive noise attenuation has a good performance in a specific frequency range. The noise attenuation frequency band of the three-way structure of reactive noise attenuation with three different inner configurations is mainly in 400-900 Hz. Compared with the three-way structure of reactive noise attenuation, the three-way structure of absorptive noise attenuation has a broader noise attenuation frequency band, and has a more smooth transmission loss curve, but has low noise attenuation characteristic in some frequency range. The three-way structure of reactive & absorptive noise attenuation has the combined characters of both the reactive noise attenuation and the absorptive noise attenuation.

Although the disclosure has been described by means of the above examples, it should be understood that the above examples are only for the purpose of illustration and are not intended to limit the disclosure. Additionally, it should be understood by those skilled in the art that the disclosure is not limited to the above examples, numerous variations and moderations can be made according to the teaching of the disclosure, which all fall into the scope claimed by the disclosure. The protection scope is defined by the appended claim set and its equivalents.

We claim:

1. A three-way structure, including a straight tube and a branch tube perpendicular to and connected with the straight tube, characterized in that the inner surface of the straight tube is provided with a hollow structure surrounding the straight tube.

2. A three-way structure according to claim 1, characterized in that the diameters of ports of the straight tube are smaller than that of the main body of the straight tube.

3. A three-way structure according to claim 1, characterized in that the hollow structure is provided symmetrically with respect to the branch tube.

4. A three-way structure according to claim 3, characterized in that the hollow structure includes chambers mounted on both sides of the branch tube and not connected with each other.

5. A three-way structure according to claim 3, characterized in that the hollow structure includes chambers which are not connected at the sides near the port of the branch tube, and are connected at the sides far from the port of the branch tube.

6. A three-way structure according to claim 4, characterized in that the chambers are filled with sound absorption material.

7. A three-way structure according to claim 6, characterized in that the sound absorption material is glass fiber.

8. A three-way structure according to claim 3, characterized in that the hollow structure is a flow channel vertically below the branch tube, and the flow channel is provided with an opening near the port of the branch tube, and the flow channel is connected with the interior of the three-way structure through the opening.

9. A three-way structure according to claim 8, characterized in that the flow channel has an annular structure.

10. A three-way structure according to claim 1, characterized in that the interior of the straight tube includes first components hermetically connected to the inner wall of the straight tube by connecting pieces; and the cross section area of the first components is smaller than that of the straight tube.

11. A three-way structure according to claim 10, characterized in that the first components have frame structures.

12. A three-way structure according to claim 11, characterized in that the first components have annular frame structures.

13. A three-way structure according to claim 11, characterized in that the three-way structure further includes a second component formed of sound absorption material, the second component having an outer contour corresponding to the inner wall of the straight tube and a facing plate with porous structure, wherein through passages along the axial direction of the straight tube are disposed in the interior of the second component, and the facing plate is in contact with the through passages.

14. A three-way structure according to claim 13, characterized in that the sound absorption material is melamine foam or sound absorption material coated with mylar and fibrous protecting layer.

15. A three-way structure according to claim 13, characterized in that the facing plate has an open cylinder shape.

16. A three-way structure according to claim 13, characterized in that the percentage of opening area of the facing plate is no less than 30%.

17. A three-way structure according to claim 13, characterized in that the three-way structure further includes a first component and a connecting piece connecting the first component with the inner wall of the straight tube configured to support the facing plate.

18. A three-way structure according to claim 5, characterized in that the chambers are filled with sound absorption material.

19. A three-way structure according to claim 18, characterized in that the sound absorption material is glass fiber.
